(19) United States
(12) Patent Application Publication
(10) Pub. No.: US 2018/0124866 A1
(43) Pub. Date: May 3, 2018

(54) TECHNIQUES FOR HIGH EFFICIENCY BASIC SERVICE SET OPERATION

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIl, San Diego, CA (US); Simone MERLIN, San Diego, CA (US); Raja BANERJEA, San Jose, CA (US)

(21) Appl. No.: 15/801,461

(22) Filed: Nov. 2, 2017

Related U.S. Application Data
(60) Provisional application No. 62/417,172, filed on Nov. 3, 2016.

(51) Int. Cl. H04W 84/12; H04W 88/08; H04W 72/04

(52) U.S. Cl. CPC H04W 84/12; H04W 12/06; H04W 72/0453; H04W 88/08

(57) ABSTRACT

Aspects of the present disclosure provide techniques for high efficiency (HE) basic service set (BSS) operations. In an implementation, a wireless station (STA) can identify a set including one or more modulation coding scheme (MCS) and number of spatial streams (NSS) tuples for HE communications in wireless local area networks (WLANs). The STA can determine whether the set is supported by a BSS and also determine that the STA is to attempt to join the BSS in response to a determination that the set is supported by the BSS. In another implementation, the STA can set a channel width capability for high throughout (HT) communications and very high throughput (VHT) communications in WLANs to be the same as a channel width capability for HE communications in WLANs, and can transmit information that indicates that the STA has the same channel width capability for HT, VHT, and HE communications in WLANs.

### CLAIM OF PRIORITY

This application claims priority to U.S. Provisional Application No. 62/417,172, title “TECHNIQUES FOR HIGH EFFICIENCY BASIC SERVICE SET OPERATION,” filed Nov. 3, 2016, which is assigned to the assignee hereof, and incorporated herein by reference in its entirety.

### BACKGROUND

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS).

With the increased use of WLANs, new implementations have been developed to address very high throughput (VHT) operations, such as IEEE 802.11ac. Even with high throughput (HT) and VHT operations available, there is a desire to provide ever increasing capabilities and efficiencies of operations.

As such, IEEE 802.11ax is currently under development and is designed to provide high efficiency (HE) operations to improve overall spectral efficiency in WLANs, especially in dense deployment scenarios.

### SUMMARY

Aspects of the present disclosure address techniques for HE BSS operation. The following description and the annexed drawings set forth in detail certain illustrative features of the one or more aspects. These features are indicative, however, of but a few of the various ways in which the principles of various aspects may be employed, and this description is intended to include all such aspects and their equivalents.

In an aspect, a method, an apparatus, and a computer-readable medium for wireless communications are described that include identifying, at an STA, a set including one or more modulation coding scheme (MCS) and number of spatial streams (NSS) tuples for HE communications in WLANs. The STA can determine whether the set is supported by a BSS and also determine that the STA is to attempt to join the BSS in response to a determination that the set is supported by the BSS.

In another aspect, a method, an apparatus, and a computer-readable medium for wireless communications are described that include setting, at an STA, a channel width capability for HT communications and VHT communications in WLANs to be the same as a channel width capability for HE communications in WLANs, and transmitting information that indicates that the STA has the same channel width capability for HT, VHT, and HE communications in WLANs.

Each of the aspects described above can also be implemented using means for performing the various functions described in connection with those aspects.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a conceptual diagram illustrating an example of a wireless local area network (WLAN) deployment;

FIG. 2 is a schematic diagram illustrating an example of an HE operation element in accordance with various aspects of the present disclosure;

FIG. 3A is a schematic diagram illustrating an example of a supported HE MCS and NSS set in accordance with various aspects of the present disclosure;

FIG. 3B is a schematic diagram illustrating an example of a basic HE MCS and NSS set in accordance with various aspects of the present disclosure;

FIG. 4 is a schematic diagram illustrating an example of various components in an STA in accordance with various aspects of the present disclosure;

FIG. 5 is a schematic diagram illustrating an example of various components in an AP in accordance with various aspects of the present disclosure;

FIG. 6 is a flow diagram illustrating an example of a method in accordance with various aspects of the present disclosure; and

FIG. 7 is a flow diagram illustrating an example of another method in accordance with aspects of the present disclosure.

### DETAILED DESCRIPTION

The present disclosure describes techniques for HE BSS operation. As described herein, these techniques may be implemented as methods, apparatuses, computer-readable media, and means for wireless communications.

As noted above, IEEE 802.11ax is currently under development and is designed to provide HE operations to improve overall spectral efficiency in WLANs, especially in dense deployment scenarios. Accordingly, various techniques are described herein to enable HE operations in basic service sets or BSSs.

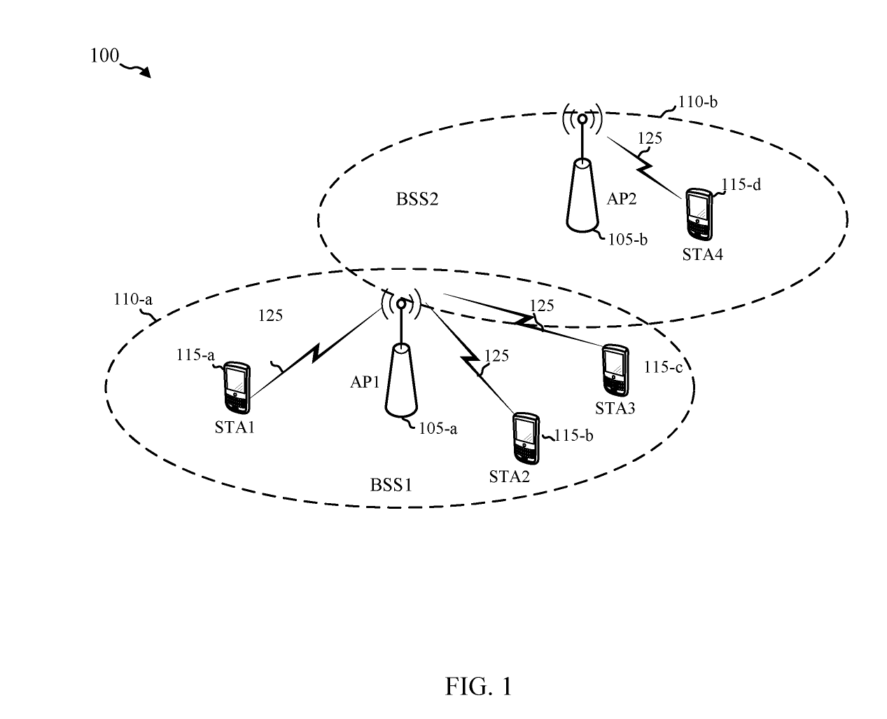

Various aspects are now described in more detail with reference to the FIGS. 1-7. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

FIG. 1 is a conceptual diagram 100 illustrating an example of a WLAN deployment in connection with various techniques described herein, including the various aspects described herein in connection with HE BSS operation. The WLAN may include one or more access points (APs) and one or more stations (STAs) associated with a respective AP. One or more of the APs and one or more of the STAs may support the techniques for HE BSS operation as described herein.

In the example of FIG. 1, there are two APs deployed: AP1 105-a in basic service set 1 (BSS1) and AP2 105-b in BSS2, which may be referred to as an OBSS. AP1 105-a is shown as having at least three associated STAs (STA1 115-a, STA2 115-b, STA3 115-c) and coverage area 110-a, while AP2 105-b is shown having one associated STA4 115-c and coverage area 110-b. The STAs and AP associated with a particular BSS may be referred to as members of that BSS. In the example of FIG. 1, the coverage area of AP1 105-a may overlap part of the coverage area of AP2 105-b such that a STA may be within the overlapping portion of the coverage areas. The number of BSSs, APs, and STAs, and the coverage areas of the APs described in connection with the WLAN deployment of FIG. 1 are provided by way of illustration and not of limitation.

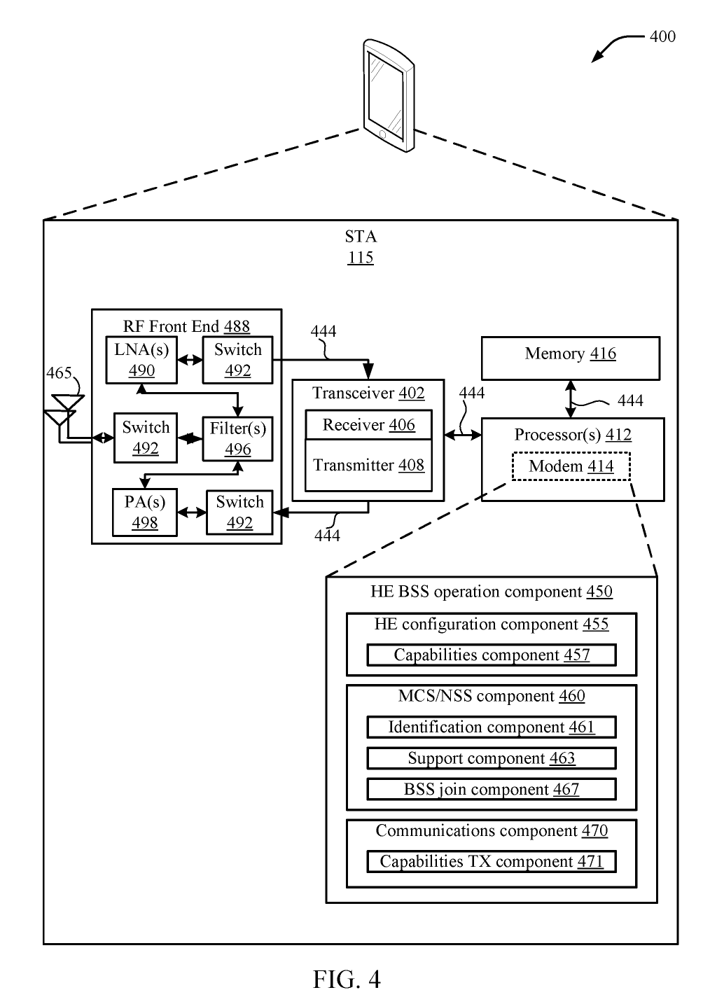

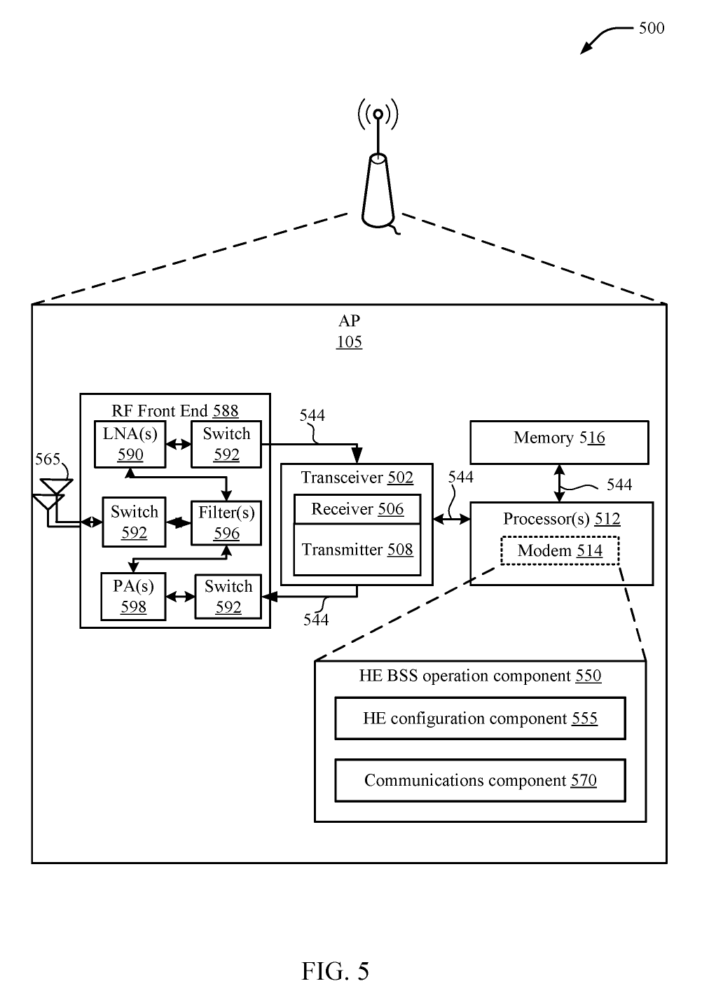

An STA in FIG. 1, or in a similar WLAN deployment, can include a modem (not shown) with an HE BSS operation component 450 as described in more detail below in FIG. 4 and that supports the HE BSS operations described in this disclosure. Similarly, an AP in FIG. 1, or in a similar deployment, can include a modem (not shown) with an HE BSS operation component 550 as described in more detail below in FIG. 5 and that supports the HE BSS operations described in this disclosure.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b, STA3 115-c, STA4 115-d) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature. In an example, an STA that supports HE BSS operations may be referred to as an HE STA. Similarly, an AP that supports HE BSS operations may be referred to as an HE AP. Moreover, an HE STA may operate as an HE AP or as an HE mesh STA, for example.

Each of STA1 115-a, STA2 115-b, STA3 115-c, STA4 115-dmay be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling).

Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STAs 115. Such systems may be referred to as an “ad-hoc” communication systems in which terminals asynchronously communication directly with each other without use of any specific AP referred to as an IBSS or mesh. Features of the present disclosure may be equally adaptable in such “ad-hoc” communication system where a broadcasting STA 115 function as the transmitting device of the plurality of multicast frames in lieu of the AP 105.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing HE BSS operations may be applicable to any suitable wireless network regardless of the coverage range and the wireless access protocols utilized.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive beacon transmissions may be referred to as a beacon interval. Transmission of a beacon may be divided into a number of groups or intervals. In one aspect, the beacon may include, but is not limited to, such information as timestamp information to set a common clock, a peer-to-peer network identifier, a device identifier, capability information, a beacon interval, transmission direction information, reception direction information, a neighbor list, and/or an extended neighbor list, some of which are described in additional detail below. Thus, a beacon may include information that is both common (e.g., shared) amongst several devices and specific to a given device.

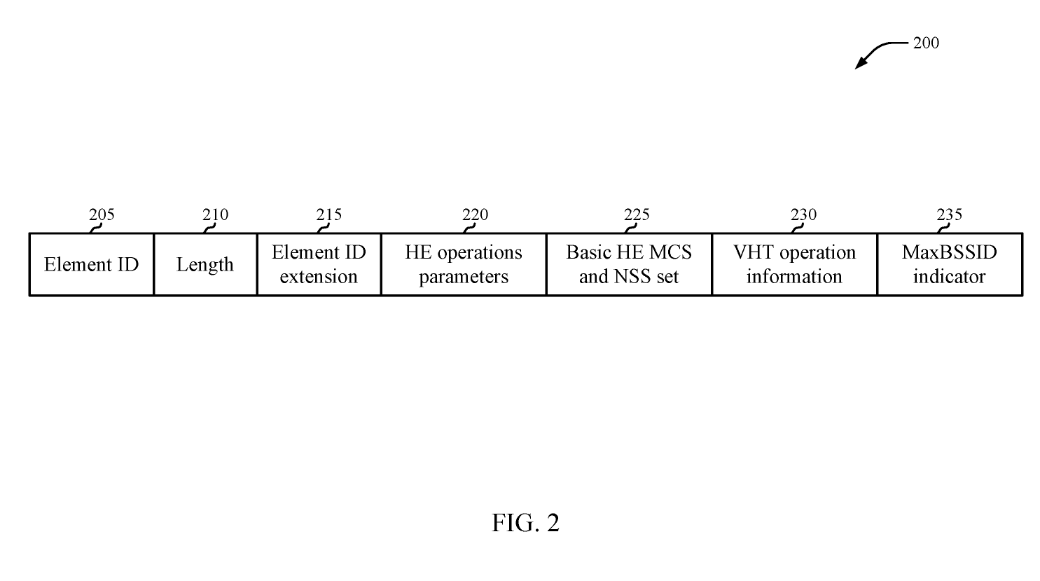

Generally, the operation of STAs that support HE (also referred to as HE STAs) in a BSS that supports HE (also referred to as an HE BSS) is controlled by an HE operation element. An HT operation element and a VHT operation element may also be involved in the operation of HE STAs. FIG. 2 is a schematic diagram 200 illustrating an example of the format of an HE operation element in accordance with various aspects of the present disclosure. In the schematic diagram 200, the HE operation element includes various fields. Those fields include an element identification (ID) (field 205), a length (field 210), an element ID extension (field 215), an HE operations parameters (field 220), a basic HE modulation coding scheme (MCS) and number of spatial streams (NSS) set (field 225), a VHT operation information (field 230), and a MaxBSSID indicator (field 235). The fields 205, 210, and 215 are typically one octet, the field 220 is typically 4 octets, the field 225 is typically 2 octets, the field 230 is typically 0 or 3 octets, and the field 235 is typically 0 or 1 octet. The schematic diagram 200 is provided by way of example and not of limitation. The HE operation element may include more or fewer fields than those shown in the schematic diagram 200. As such, the HE operation element may include additional fields not shown in the schematic diagram 200 and/or may have one or more of the fields shown in the schematic diagram 200 removed. In one example, the MaxBSSID indicator (field 235) may be omitted.

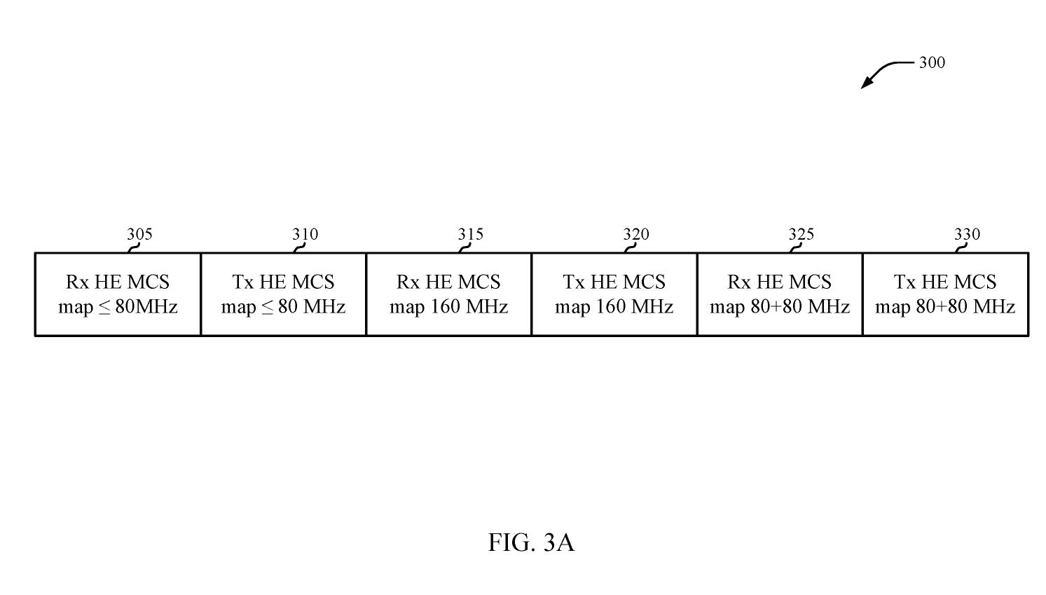

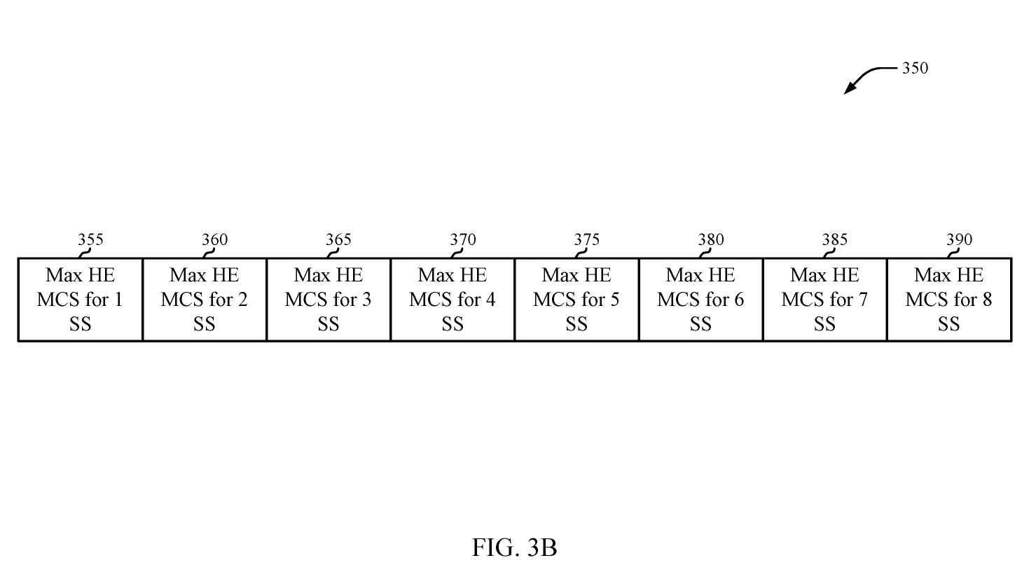

FIG. 3A is a schematic diagram 300 illustrating an example of the format or structure of a supported HE MCS and NSS set field. Such a field may be found in, for example, an HE capabilities element of an MLME-START.request primitive (where MLME refers to medium access control (MAC) sublayer management entity). The supported HE MCS And NSS set field is used to convey the combinations of HE-MCSs and spatial streams that an STA supports for reception and the combinations that it supports for transmission. In the schematic diagram 300, the supported HE MCS and NSS set field includes various subfields. Those subfields include a reception (Rx) HE MCS map≤80 MHz (subfield 305), a transmission (Tx) HE MCS map≤80 MHz (subfield 310), an Rx HE MCS map 160 MHz (subfield 315), a Tx HE MCS map 160 MHz (subfield 320), an Rx HE MCS map 80+80 MHz (subfield 325), and a Tx HE MCS map 80+80 MHz (subfield 330). The subfields 305 and 310 are typically two octets, and the subfields 315, 320, 325, and 330 are typically 0 or 2 octets.

The Rx HE MCS map≤80 MHz indicates a (subfield 305) maximum value of an RXVECTOR parameter MCS of a PLCP protocol data unit or PPDU that can be received at all channel widths less than or equal to 80 MHz supported by the STA for each number of spatial streams. Similarly, the Tx HE MCS map≤80 MHz (subfield 310) indicates a maximum value of an TXVECTOR parameter MCS of a PPDU that can be transmitted at all channel widths less than or equal to 80 MHz supported by the STA for each number of spatial streams.

The Rx HE MCS map 160 MHz (subfield 315) indicates a maximum value of an RXVECTOR parameter MCS of a PPDU that can be received at 160 MHz channel width supported by the STA for each number of spatial streams. Similarly, the Tx HE MCS map 160 MHz (subfield 320) indicates a maximum value of an TXVECTOR parameter MCS of a PPDU that can be transmitted at 160 MHz channel width supported by the STA for each number of spatial streams.

The Rx HE MCS map 80+80 MHz (subfield 325) indicates a maximum value of an RXVECTOR parameter MCS of a PPDU that can be received at 80+80 MHz channel width supported by the STA for each number of spatial streams. Similarly, the Tx HE MCS map 80+80 MHz (subfield 330) indicates a maximum value of an TXVECTOR parameter MCS of a PPDU that can be transmitted at 80+80 MHz channel width supported by the STA for each number of spatial streams.

Each Rx HE MCS map subfield and each Tx HE MCS map subfield described above may have a structure or format as described below in connection with FIG. 3B.

FIG. 3B is a schematic diagram 300 illustrating an example of the format of a basic HE MCS and NSS set in accordance with various aspects of the present disclosure. In the schematic diagram 300, the basic HE MCS and NSS set (which may be an example or indication of content in the field 225 in FIG. 2 and/or the Rx/Tx HE MCS map subfields described above in FIG. 3A) includes various subfields, one for each of n=1, . . . , 8 spatial streams or SS. The basic HE MCS and NSS set may also be referred to as the HE-MCS and NSS set. Those subfields include a maximum (Max) HE MCS for 1 SS (subfield 355), a Max HE MCS for 2 SS (subfield 360), a Max HE MCS for 3 SS (subfield 365), a Max HE MCS for 4 SS (subfield 370), a Max HE MCS for 5 SS (subfield 375), a Max HE MCS for 6 SS (subfield 380), a Max HE MCS for 7 SS (subfield 385), and a Max HE MCS for 8 SS (subfield 390). Each of the subfields 355, 360, 365, 370, 375, 380, 385, and 390 may include up to 2 bits.

In an aspect, the HE operation element format in FIG. 2 or the Rx/Tx HE MCS map subfields in FIG. 3A may reflect that the number of octets for the basic HE MCS and NSS set is 2 as indicated above. Accordingly, regarding the description of the basic HE MCS and NSS set format in FIG. 3B, the bitmap of size 16 bits. That is, there are 8 subfields of 2 bits each for a total bitmap size of 16 bits. As such, each subfield may have a 2 bit value in the bitmap. Therefore, the basic HE MCS and NSS set format may reflect that the number of bits per Max HE MCS for NSS n subfield is 2 bits. Moreover, the bit numbering for each subfield may correspond to the bit count. For example, for the HE MCS for 1 SS (subfield 355) the bits are B0-B1, for the Max HE MCS for 2 SS (subfield 360) the bits are B2-B3, for the Max HE MCS for 3 SS (subfield 365) the bits are B4-B5, for the Max HE MCS for 4 SS (subfield 370) the bits are B6-B7, for the Max HE MCS for 5 SS (subfield 375) the bits are B8-B9, for the Max HE MCS for 6 SS (subfield 380) the bits are B10-B11, for the Max HE MCS for 7 SS (subfield 385) the bits are B12-B13, and for the Max HE MCS for 8 SS (subfield 390) the bits are B14-B15.

Regarding the HE operation element and/or the Rx/Tx HE MCS map subfields, the following may also be considered. The Max HE MCS for n SS subfields (where n=1, . . . , 8) may be encoded using two bits as follows:
0 indicates support for HE MCS 0-7 for n spatial streams,
1 indicates support for HE MCS 0-9 for n spatial streams,
2 indicates support for HE MCS 0-11 for n spatial streams, and
3 indicates no support n spatial streams.

For HE BSS operations, an AP or an STA that operates as an AP (e.g., an AP-STA) that sets up a BSS for HE operations may require a set of minimum capabilities from any STA in order to allow that STA to associate with the AP. In general, the AP that sets up the HE BSS wants to ensure that a set of MCS and NSS and corresponding parameters for HE operations are supported and the AP delivers this information in the HE operation element (see e.g., FIG. 2) to STAs that intend to associate or join the AP so that the STAs can commit to supporting these capabilities because the AP will use them to communicate with the STA (e.g., the AP will broadcast frames using the set and parameters).

With respect to HE BSS operation, and more particularly, the basic HE BSS functionality, an HE STA has dot11HEOptionImplemented equal to true. An HE capabilities element is present when dot1HEOptionImplemented is true, otherwise it is not present. Moreover, an STA (e.g., an AP-STA) that is starting an HE BSS may be able to receive and transmit at each of the <HE MCS, NSS>tuple values indicated by the basic HE MCS and NSS set field of an HE operation parameter (e.g., two bits) of the MLME-START.request primitive and may be able to receive at each of the <HE MCS, NSS> tuple values indicated by the supported HE MCS and NSS set field (see e.g., FIG. 3A) of the HE capabilities parameter of the MLME-START.request primitive. An <HE MCS, NSS> tuple value may refer to a value that indicates a particular pair of an MCS and a corresponding NSS used for HE operations.

The basic HE MCS and NSS set is the set of <HE-MCS, NSS> tuples that are supported by all HE STAs that are members of an HE BSS. It is established by the STA (e.g., an AP-STA) that starts the HE BSS, indicated by the basic HE MCS and NSS set field of an HE operation parameter in the MLME-START.request primitive. Other HE STAs determine the basic HE MCS and NSS set from the basic HE MCS and NSS set field of the HE operation element (see e.g., HE operation element format in FIG. 2) in a BSSDescription derived through a scan mechanism.

An HE STA may not attempt to join (MLME-JOIN.request primitive) a BSS unless it supports (e.g., is able to both transmit and receive using) all of the <HE MCS, NSS> tuples in the basic HE MCS and NSS set. In one aspect, an HE STA does not attempt to (re)associate with an HE AP unless the STA supports (e.g., is able to both transmit and receive using) all of the <HE MCS, NSS> tuples in the basic HE MCS and NSS set field in the HE operation element transmitted by the AP because the MLME-JOIN.request primitive is a precursor to (re)association.

In another aspect related to HE BSS operations, an STA that has set dot11HEOptionImplemented to true may set dot11HighThroughputOptionImplemented to true when operating in the 2.4 GHz band. An STA that sets dot11HEOptionImplemented to true may set dot11VeryHighThroughputOptionImplemented and dot11HighThroughputOptionImplemented to true when operating in the 5 GHz band. A non-AP STA that sets dot11HEOptionImplemented to true may set dot11MuliBSSIDIImplemented to true. In an aspect, if an STA is operating in 2.4 GHz it may not be considered a VHT STA.

In yet another aspect, an STA that is an HE AP or an HE mesh STA may declare its channel width capability in an HE capabilities element (e.g., as described in subfields of an HE PHY capabilities information field). If the STA is an HE AP then it may indicate support for at least 80 MHz channel width if it operates in 5 GHz, otherwise the STA may indicate any channel width support.

In another aspect, an STA may set or configure a supported channel width set subfield of a VHT capabilities element and an HT capabilities element that the STA transmits to a value that indicates the same channel width capability as a channel width capability provided in an HE capabilities element that the STA transmits. One exception may be when an STA is a 20 MHz-only non-AP HE STA in which case the supported channel width set subfield of the VHT capabilities element may be reserved. In another aspect, an STA may set all the subfields of the VHT capabilities and HT capabilities element it transmits to respective values that indicate the same capabilities provided in the HE capabilities element it transmits. In an aspect, the VHT capabilities element may not be transmitted in 2.4 GHz.

At least, an HE STA may set a Rx MCS bitmask of a supported MCS set field of its HT capabilities element according to the setting of each Rx HE MCS map for b subfield , where b is for ≤80 MHz, 160 MHz, 80+80 MHz, of the supported HE MCS and NSS set field of its HE capabilities element as follows: for each subfield Max HE MCS for n SS, 1<n<4, of each Rx HE MCS map b subfield with a value other than 3 (no support for that number of spatial streams), the STA may indicate support for MCSs 8(n−1) to 8(n−1)+7 in the Rx MCS bitmask, where n is the number of spatial streams, except for those MCSs marked or identified as not being unsupported. There may be additional rate selection constraints for HE PLCP protocol data units or PPDUs.

An STA that is a HE AP or a HE mesh STA that transmits an HE operation element that has a VHT operation information preset field set to 1 may set the STA channel width subfield in an HT operation element HT operation information field, a channel width, a channel center frequency segment 0 and a channel center frequency segment 1 subfields in the HE operation element VHT operation information field to indicate the BSS bandwidth as defined in, for example, a table (VHT BSS bandwidth). The setting of the channel center frequency segment 0 and channel center frequency segment 1 subfields may be performed in connection with a table that describes, for example, the setting of the channel center frequency segment 0, the channel center frequency segment 1, and a channel center frequency segment 2 subfields, except that a Max NSS support may be provided by an HE STA in frames that contain an HE capabilities element (see e.g., HE capabilities element used by an HE STA to declare it is an HE STA) and an operating mode field (see e.g., information related to operating mode (OM) change and operating mode field), wherein in the table the Max NSS support refers to the HE Max NSS support instead of the VHT Max NSS support for an HE STA.

In another aspect, an HE STA may determine the channelization using the information in a primary channel field of an HT operation element when operating in 2.4 GHz and the combination of the information in the primary channel field of the HT operation element and the channel center frequency segment 0 and the channel center frequency segment 1 subfields of an VHT operation information field in a VHT operation element (see e.g., field 230 in an HE operation element in FIG. 2) when operating in 5 GHz.

An HE AP or an HE mesh STA may set a secondary channel offset subfield in an HT operation information field in an HT operation element to indicate a secondary 20 MHz channel if the BSS bandwidth is more than 20 MHz. In an aspect, the secondary channel bandwidth may be defined in, for example, a table including information related to HT operation element fields and subfields.

An HE STA that is a member of an HE BSS may follow rules defined in connection with a basic VHT BSS functionality when transmitting 20 MHz, 40 MHz, 80 MHz, 160 MHz, or 80+80 MHz HE PPDUs with some exceptions.

In a first exception, an HE trigger-based (TB) PPDU sent in response to a trigger frame or a frame with an uplink (UL) multi-user (MU) response scheduling A-control field (UMRS control field) may follow instead rules defined in connection with STA behavior.

In a second exception, an 80 MHz, 160 MHz, or 80+80 MHz downlink (DL) HE MU PPDU with preamble puncturing may be transmitted if either a primary 20 MHz or a primary 40 MHz, or both are occupied by the transmission as defined for a physical layer (PHY).

In an aspect, an HE STA may not transmit to a second HE STA using a bandwidth that is not indicated as supported in a channel width set subfield in an HE capabilities element received from that HE STA.

In another aspect, an STA may not transmit a MAC packet data unit (MPDU) in an HE PPDU to an STA that exceeds a maximum MPDU length capability indicated in a VHT capabilities element received from the recipient STA or that exceeds a maximum aggregate MAC service data unit (A-MSDU) length in an HT capabilities element received from the recipient STA.

In another aspect, an STA may not transmit an A-MPDU in a HE PPDU to an STA that exceeds a maximum A-MPDU length capability indicated in an HE capabilities element, a VHT capabilities element, and an HT capabilities element received from the recipient STA. The maximum A-MPDU length capability is obtained as a combination of a maximum A-MPDU length exponent subfields in the HE capabilities element and the VHT capabilities element if the recipient STA has transmitted the VHT capabilities; otherwise it is obtained from a combination of a maximum A-MPDU length exponent subfields in the HE capabilities element and the HT capabilities element.

In an aspect, an HE AP may set a reduced interframe space (RIFS) mode field in an HT operation element to 0.

In an aspect, an HE STA may follow rules defined for VHT BSS operation for channel selection, determining scanning requirements, channel switching, network allocation vector (NAV) assertion, and antenna indication when operating in 5 GHz unless explicitly stated otherwise.

In another aspect, an HE STA may follow rules defined for 20/40 MHz BSS operation for channel selection, determining scanning requirements, channel switching, NAV assertion when operating in 2.4 GHz unless explicitly stated otherwise.

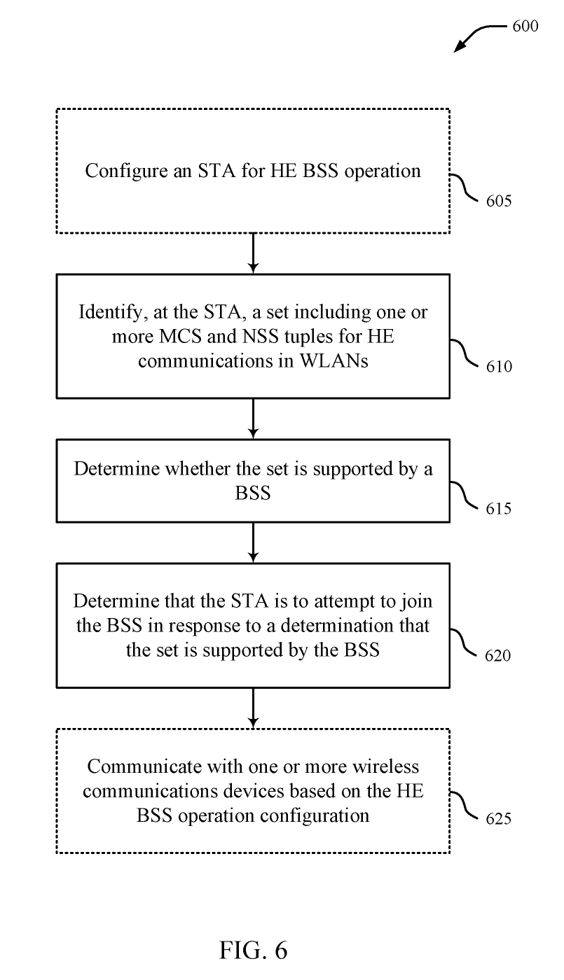

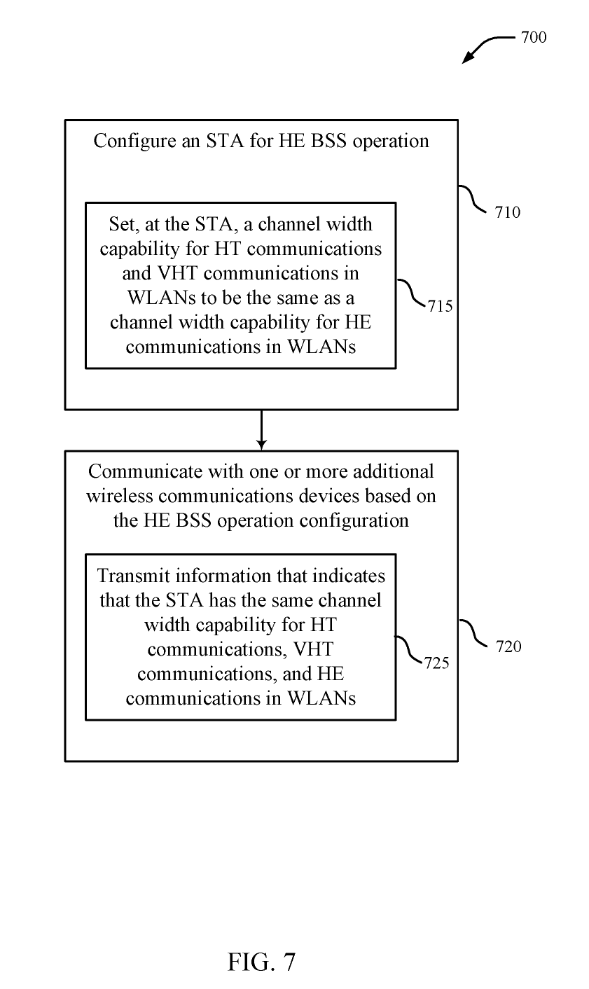

The various aspects described above in connection with HE BSS operations may be performed by the devices described below in FIGS. 4 and 5 at least in accordance with the methods described in FIGS. 6 and 7.

FIG. 4 describes hardware components and subcomponents of a wireless communications device (e.g., STA 115) for implementing the techniques for HE BSS operation provided by this disclosure. For example, one example of an implementation of the STA 115 may include a variety of components, including components such as one or more processors 412, a memory 416, a transceiver 402, and a modem 414 in communication via one or more buses 444, which may operate in conjunction with an HE BSS operation component 450 to enable one or more of the functions described herein as well as one or more methods (e.g., methods 600 and 700) of the present disclosure. For example, the one or more processors 412, the memory 416, the transceiver 402, and/or the modem 414 may be communicatively coupled via the one or more buses 444. Further, the one or more processors 412, the modem 414, the memory 416, the transceiver 402, as well as RF front end 488 and one or more antennas 465, may be configured to support HE BSS operations. In an example, the HE BSS operation component 450 may configure HE BSS operations and may use the configuration to assist the wireless communications device perform HE BSS operations, including communication with other devices.

In an aspect, the one or more processors 412 may include the modem 414 that may use one or more modem processors. The various functions related to the HE BSS operation component 450 may be included in the modem 414 and/or the one or more processors 412 and, in an aspect, can be executed by a single processor, while in other aspects, different ones of the functions may be executed by a combination of two or more different processors. For example, in an aspect, the one or more processors 412 may include any one or any combination of a modem processor, or a baseband processor, or a digital signal processor, or a transmit processor, or a receiver processor, or a transceiver processor associated with the transceiver 402. In other aspects, some of the features of the one or more processors 412 and/or the modem 414 associated with the HE BSS operation component 450 may be performed by the transceiver 402.

Also, the memory 416 may be configured to store data used herein and/or local versions of applications or the HE BSS operation component 450 and/or one or more of its subcomponents being executed by at least one processor 412. The memory 416 can include any type of computer-readable medium usable by a computer or at least one processor 412, such as random access memory (RAM), read only memory (ROM), tapes, magnetic discs, optical discs, volatile memory, non-volatile memory, and any combination thereof. In an aspect, for example, the memory 416 may be a non-transitory computer-readable storage medium that stores one or more computer-executable codes defining the HE BSS operation component 450 and/or one or more of its subcomponents, and/or data associated therewith, when the STA 115 is operating at least one processor 412 to execute the HE BSS operation component 450 and/or one or more of its subcomponents.

The transceiver 402 may include at least one receiver 406 and at least one transmitter 408. The receiver 406 may include hardware, firmware, and/or software code executable by a processor for receiving data, the code comprising instructions and being stored in a memory (e.g., computer-readable medium). The receiver 406 may be, for example, a radio frequency (RF) receiver. In an aspect, the receiver 406 may receive signals transmitted by at least one AP 105 or another STA 115. Additionally, the receiver 406 may process such received signals, and also may obtain measurements of the signals, such as, but not limited to, Ec/lo, SNR, RSRP, RSSI, etc. The transmitter 408 may include hardware, firmware, and/or software code executable by a processor for transmitting data, the code comprising instructions and being stored in a memory (e.g., computer-readable medium). A suitable example of the transmitter 408 may include, but is not limited to, an RF transmitter.

Moreover, in an aspect, the wireless communications device or STA 115 may include the RF front end 488 mentioned above, which may operate in communication with the one or more antennas 465 and the transceiver 402 for receiving and transmitting radio transmissions, for example, wireless communications transmitted by at least one AP 105 or wireless communications transmitted by another STA 115. The RF front end 488 may be connected to the one or more antennas 465 and can include one or more low-noise amplifiers (LNAs) 490, one or more switches 492, one or more power amplifiers (PAs) 498, and one or more filters 496 for transmitting and receiving RF signals.

In an aspect, the LNA 490 can amplify a received signal at a desired output level. In an aspect, each LNA 490 may have a specified minimum and maximum gain values. In an aspect, the RF front end 488 may use the one or more switches 492 to select a particular LNA 490 and its specified gain value based on a desired gain value for a particular application.

Further, for example, the one or more PA(s) 498 may be used by the RF front end 488 to amplify a signal for an RF output at a desired output power level. In an aspect, each PA 498 may have specified minimum and maximum gain values. In an aspect, the RF front end 488 may use the one or more switches 492 to select a particular PA 498 and its specified gain value based on a desired gain value for a particular application.

Also, for example, the one or more filters 496 may be used by the RF front end 488 to filter a received signal to obtain an input RF signal. Similarly, in an aspect, for example, a respective filter 496 can be used to filter an output from a respective PA 498 to produce an output signal for transmission. In an aspect, each filter 496 can be connected to a specific LNA 490 and/or PA 498. In an aspect, the RF front end 488 can use one or more switches 492 to select a transmit or receive path using a specified filter 496, LNA 490, and/or PA 498, based on a configuration as specified by the transceiver 402 and/or the one or more processors 412.

As such, the transceiver 402 may be configured to transmit and receive wireless signals through the one or more antennas 465 via the RF front end 488. In an aspect, the transceiver 402 may be tuned to operate at specified frequencies such that wireless communications device or STA 115 can communicate with, for example, one or more STAs 115 or one or more BSSs associated with one or more APs 105. In an aspect, for example, the modem 414 can configure the transceiver 402 to operate at a specified frequency and power level based on the configuration of the wireless communications device or STA 115 and the communication protocol used by the modem 414.

In an aspect, the modem 414 can be a multiband-multimode modem, which can process digital data and communicate with the transceiver 402 such that the digital data is sent and received using the transceiver 402. In an aspect, the modem 414 can be multiband and be configured to support multiple frequency bands for a specific communications protocol. In an aspect, the modem 414 can be multimode and be configured to support multiple operating networks and communications protocols. In an aspect, the modem 414 can control one or more components of wireless communications device or STA 115 (e.g., the RF front end 488, the transceiver 402) to enable transmission and/or reception of signals from the network based on a specified modem configuration. In an aspect, the modem configuration may be based on the mode of the modem and the frequency band in use. In another aspect, the modem configuration may be based on STA configuration information associated with wireless communications device or STA 115 as provided by the network.

The HE BSS operation component 450 can include an HE configuration component 455, and MCS/NSS component 460, and a communications component 470. Each of these components can be implemented using hardware, software, or a combination of both.

The HE configuration component 455 configured the wireless communications device or STA 115 for HE BSS operations.

The MCS/NSS component 460 performs various aspects described herein in connection with the basic HE MCS and NSS set and MCS and NSS tuples (e.g., <HE MCS, NSS> tuple values).

The communications component 470 configures and/or performs aspects related to the transmission and/or reception of information (e.g., elements) for HE BSS operations from the perspective of an STA.

In an aspect, the HE configuration component 455 may include a capabilities component 457 that sets a channel width capability for HT communications and VHT communications in WLANs to be the same as a channel width capability for HE communications (e.g., HE BSS operations) in WLANs.

In another aspect, the MCS/NSS component 460 may include an identification component 461, a support component 463, and a BSS join component 467.

The identification component 461 that identifies, a set including one or more MCS and NSS tuples for HE communications in WLANs. For example, the identification component 461 may identify a basic HE MCS and NSS set and/or the <HE MCS, NS> tuple values associated with the basic HE MCS and NSS set.

The support component 463 determines whether the set is supported by a BSS.

The BSS join component 467 determines whether the wireless communications device or STA 115 is to attempt to join the BSS in response to a determination that the set is supported by the BSS.

The communications component 470 may include a capabilities transmission (TX) component 471 that transmits information indicating that the STA has the same channel width capability for HT communications, VHT communications, and HE communications in WLANs

While the hardware description in FIG. 4 has been provided with respect to a wireless communications device or STA 115 that supports HE BSS operations, the same or similar hardware structure may be used for an AP that supports HE BSS operations. Moreover, the same or similar hardware structure may be used by an STA that supports HE BSS operations while operating as an AP or as a mesh STA.

For example, FIG. 5 describes hardware components and subcomponents of an AP 105 or AP-STA for implementing the techniques for HE BSS operation provided by this disclosure. The AP 105 may include one or more processors 512, a memory 516, a modem 514, and a transceiver 502, which may communicate between them using a bus 544. For example, the one or more processors 512, the memory 516, the transceiver 502, and/or the modem 514 may be communicatively coupled via the one or more buses 544. The transceiver 502 may include a receiver 506 and a transmitter 508. Moreover, the AP 105 may include an RF front end 588 and one or more antennas 565, where the RF front end 588 may include LNA(s) 590, switches 592, filters 596, and PA(s) 598. Each of these components or subcomponents of the AP 105 may operate in a similar manner as the corresponding components described above in connection with FIG. 4.

The one or more processors 512, the memory 516, the transceiver 502, and the modem 514 may operate in conjunction with an HE BSS operation component 550 to enable one or more of the functions described herein in connection with an AP or AP-STA that starts or establishes an HE BSS.

The HE BSS operation component 550 may include an HE configuration component 555 that provides information associated with the configuration or establishment of an HE BSS. In an example, the HE configuration component 555 can set up and inform (e.g., provide or send parameters information) of the minimum requirements that an STA has to support to join an HE BSS.

The HE BSS operation component 550 may also include a communications component 570 that configures and/or performs aspects related transmission and/or reception of information (e.g., elements) for HE BSS operations from the perspective of an AP or AP-STA.

FIG. 6 is a flowchart of an example method 600 of aspects of the present disclosure. The method 600 may be performed by a wireless communications device (e.g., STA 115) as described with reference to FIGS. 1 and 4. Although the method 600 is described below with respect to the components of the STA 115, other components may be used to implement one or more of the actions described herein.

At block 605, the method 600 may (optionally) include a configuration of a wireless communications device or STA 115 for HE BSS operation. In an aspect, the configuration may be performed by the one or more processors 412, the modem 414, the HE BSS operation component 450, and/or the HE configuration component 455.

At block 610, the method 600 may include an identification, at the wireless communications device or STA 115, or a set (e.g., a basic HE MCS and NSS set) including one or more MCS and NSS tuples (e.g., tuple values) for HE communications in WLANs. In an aspect, the identification may be performed by the one or more processors 412, the modem 414, the HE BSS operation component 450, the MCS/NSS component 460, and/or the identification component 461.

At block 615, the method 600 may include a determination of whether the set is supported by a BSS. In an aspect, the determination may be performed by the one or more processors 412, the modem 414, the HE BSS operation component 450, the MCS/NSS component 460, and/or the support component 463.

At block 620, the method 600 may include a determination that the wireless communications device or STA is to attempt to join the BSS in response to a determination that the set is supported by the BSS. In an aspect, the determination may be performed by the one or more processors 412, the modem 414, the HE BSS operation component 450, the MCS/NSS component 460, and/or the BSS join component 467.

At block 625, the method 600 may (optionally) include communication with one or more additional wireless communications devices (e.g., other STAs 115 or an AP 105) based on the HE BSS operation configuration and after the wireless communications device or STA 115 joins the BSS. In an aspect, the communication may be performed by the one or more antennas 465, the RF front end 488, the transceiver 402, the one or more processors 412, the modem 414, the HE BSS operation component 450, and/or the communications component 470.

In another aspect of the method 600, the method may include associating with an AP of the BSS in response to a determination that the STA is to attempt to join the BSS, and communicating with the AP based on at least one of the MCS and NSS tuples in the set in response to a successful association by the STA with the AP.

In another aspect of the method 600, the STA is a non-AP STA (e.g., an STA that does not operate or function as an AP).

In another aspect of the method 600, the method includes receiving an HE operation element with information about the MCS and NSS tuples in the set.

In another aspect of the method 600, the set is a basic HE MCS and NSS set including n spatial stream subfields and each subfield includes multiple bits to represent a maximum (Max) HE MCS for a corresponding n spatial streams. In another aspect, n=1, . . . , 8 and the multiple bits include only two bits. In yet another aspect, the two bits provide four values to represent the Max HE MCS for a corresponding n spatial streams based on the following encoding: 0 indicates support for HE MCS 0-7 for n spatial streams, 1 indicates support for HE MCS 0-9 for n spatial streams, 2 indicates support for HE MCS 0-11 for n spatial streams, and 3 indicates no support n spatial streams.

In another aspect of the method 600, the method may include determining that the STA is not to attempt to join the BSS in response to a determination that the BSS does not support the set.

FIG. 7 is a flowchart of an example method 700 of aspects of the present disclosure. The method 700 may be performed by a wireless communications device (e.g., STA 115) as described with reference to FIGS. 1 and 4. Although the method 700 is described below with respect to the components of the STA 115, other components may be used to implement one or more of the actions described herein.

At block 710, the method 700 may include a configuration of a wireless communications device or STA 115 for HE BSS operation. In an aspect, the configuration may be performed by the one or more processors 412, the modem 414, the HE BSS operation component 450, and/or the HE configuration component 455.

At block 715 in block 710, the method 700 may include setting, at the STA, a channel width capability for HT communications and VHT communications in WLANs to be the same as a channel width capability for HE communications in WLANs. In an aspect, the setting may be performed by the one or more processors 412, the modem 414, the HE BSS operation component 450, the HE configuration component 455, and/or the capabilities component 457.

At block 720, the method 700 may include communication with one or more additional wireless communications devices based on the HE BSS operation configuration. In an aspect, the communication may be performed by the one or more antennas 465, the RF front end 488, the transceiver 402, the one or more processors 412, the modem 414, the HE BSS operation component 450, and/or the communications component 470.

At block 725 in block 720, the method 700 may include transmission of information that indicates that the STA has the same channel width capability for HT communications, VHT communications, and HE communications in WLANs. In an aspect, the communication may be performed by the one or more antennas 465, the RF front end 488, the transceiver 402, the one or more processors 412, the modem 414, the HE BSS operation component 450, the communications component 470, and/or the capabilities TX component 471.

In an aspect of the method 700, the STA is configured to operate as an HE AP.

In an aspect of the method 700, the STA is configured to operate as an HE mesh STA.

In an aspect of the method 700, the transmitting of information includes the identification and transmission of a value in each of an HT capabilities element, a VHT capabilities element, and an HE capabilities element to indicate that the STA supports the same channel width capability in HT communications, VT communications, and HE communications in WLANs.

In an aspect of the method 700, the channel width capability supported by the STA is at least 80 MHz during operation of the STA at 5 GHz.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for.”

What is claimed is:

1. A method for wireless communications, comprising:
identifying, at a wireless station (STA), a set including one or more modulation coding scheme (MCS) and number of spatial streams (NSS) tuples for high efficiency (HE) communications in wireless local area networks (WLANs);
determining whether the set is supported by a basic service set (BSS); and
determining that the STA is to attempt to join the BSS in response to a determination that the set is supported by the BSS.

2. The method of claim 1, further comprising:
associating with an access point (AP) of the BSS in response to a determination that the STA is to attempt to join the BSS; and
communicating with the AP based on at least one of the MCS and NSS tuples in the set in response to a successful association by the STA with the AP.

3. The method of claim 1, wherein the STA is a non-AP STA.

4. The method of claim 1, further comprising receiving an HE operation element with information about the MCS and NSS tuples in the set.

5. The method of claim 1, wherein the set is a basic HE MCS and NSS set including n spatial stream subfields and each subfield includes multiple bits to represent a maximum (Max) HE MCS for a corresponding n spatial streams.

6. The method of claim 5, wherein n=1, . . . , 8 and the multiple bits include only two bits.

7. The method of claim 6, wherein the two bits provide four values to represent the Max HE MCS for a corresponding n spatial streams based on the following encoding:
0 indicates support for HE MCS 0-7 for n spatial streams,
1 indicates support for HE MCS 0-9 for n spatial streams,
2 indicates support for HE MCS 0-11 for n spatial streams, and
3 indicates no support for n spatial streams.

8. The method of claim 1, further comprising determining that the STA is not to attempt to join the BSS in response to a determination that the BSS does not support the set.

9. A method for wireless communications, comprising:
setting, at a wireless station (STA), a channel width capability for high throughout (HT) communications and very high throughput (VHT) communications in wireless local area networks (WLANs) to be the same as a channel width capability for high efficiency (HE) communications in WLANs; and
transmitting information that indicates that the STA has the same channel width capability for HT communications, VHT communications, and HE communications in WLANs.

10. The method of claim 9, wherein the STA is configured to operate as an HE access point (AP).

11. The method of claim 9, wherein the STA is configured to operate as an HE mesh STA.

12. The method of claim 9, wherein transmitting information includes identifying and transmitting a value in each of an HT capabilities element, a VHT capabilities element, and an HE capabilities element to indicate that the STA supports the same channel width capability in HT communications, VT communications, and HE communications in WLANs.

13. The method of claim 9, wherein the channel width capability supported by the STA is at least 80 MHz during operation of the STA at 5 GHz.

14. An apparatus for wireless communications, comprising:
a transceiver;
a memory configured to store instructions; and
a processor communicatively coupled with the memory, the processor configured to execute the instructions to:
identify, at a wireless station (STA), a set including one or more modulation coding scheme (MCS) and number of spatial streams (NSS) tuples for high efficiency (HE) communications in wireless local area networks (WLANs);
determine whether the set is supported by a basic service set (BSS); and
determine that the STA is to attempt to join the BSS in response to a determination that the set is supported by the BSS.

15. The apparatus of claim 14, wherein the processor is further configured to execute the instructions to:
associate the STA with an access point (AP) of the BSS in response to a determination that the STA is to attempt to join the BSS; and
communicate with the AP based on at least one of the MCS and NSS tuples in the set in response to a successful association by the STA with the AP.

16. The apparatus of claim 14, wherein the STA is a non-AP STA.

17. The apparatus of claim 14, wherein the processor is further configured to execute the instructions to receive, via the transceiver, an HE operation element with information about the MCS and NSS tuples in the set.

18. The apparatus of claim 14, wherein the set is a basic HE MCS and NSS set including n spatial stream subfields and each subfield includes multiple bits to represent a maximum (Max) HE MCS for a corresponding n spatial streams.

19. The apparatus of claim 18, wherein n=1, . . . , 8 and the multiple bits include only two bits.

20. The apparatus of claim 19, wherein the two bits provide four values to represent the Max HE MCS for a corresponding n spatial streams based on the following encoding:
0 indicates support for HE MCS 0-7 for n spatial streams,
1 indicates support for HE MCS 0-9 for n spatial streams,
2 indicates support for HE MCS 0-11 for n spatial streams, and
3 indicates no support n spatial streams.

21. The apparatus of claim 14, wherein the processor is further configured to execute the instructions to determine that the STA is not to attempt to join the BSS in response to a determination that the BSS does not support the set.

22. An apparatus for wireless communications, comprising:
a transceiver;
a memory configured to store instructions; and
a processor communicatively coupled with the memory, the processor configured to execute the instructions to:
set, at a wireless station (STA), a channel width capability for high throughout (HT) communications and very high throughput (VHT) communications in wireless local area networks (WLANs) to be the same as a channel width capability for high efficiency (HE) communications in WLANs; and
transmit, via the transceiver, information that indicates that the STA has the same channel width capability for HT communications, VHT communications, and HE communications in WLANs.

23. The apparatus of claim 22, wherein the STA is configured to operate as an HE access point (AP).

24. The apparatus of claim 22, wherein the STA is configured to operate as an HE mesh STA.

25. The apparatus of claim 22, wherein the processor configured to execute the instructions to transmit information is further configured to execute the instructions to identify and transmit a value in each of an HT capabilities element, a VHT capabilities element, and an HE capabilities element to indicate that the STA supports the same channel width capability in HT communications, VT communications, and HE communications in WLANs.

26. The apparatus of claim 22, wherein the channel width capability supported by the STA is at least 80 MHz during operation of the STA at 5 GHz.
